(19) United States
(12) Patent Application Publication
(10) Pub. No.: US 2004/0085218 A1
(43) Pub. Date: May 6, 2004

(54) Method and apparatus for displaying homeland security advisory information

(75) Inventor: Gene Pecora, Farmington, CT (US)

Correspondence Address: BAKER & HOSTETLER LLP, Washington Square, Suite 1100, 1050 Connecticut Avenue, N.W., WASHINGTON, DC, 20036, US

(73) Assignee: Edwards Systems Technology, Inc.

(21) Appl. No.: 10/284,309

(22) Filed: Oct. 31, 2002

(51) Int. Cl. G08B 5/00

(52) U.S. Cl. 340/815.4; 340/691.6

(57) ABSTRACT

A method and apparatus displays homeland security advisory system information. The apparatus includes a beacon having an illuminous display configured to illuminate a color, and a controller configured to cause the display to selectively illuminate a red, orange, yellow, blue and green color. The controller is configured to receive and respond to a signal to illuminate one of the colors. The method includes providing a security alert beacon, selecting a color for the security alert beacon to display, and manipulating the beacon to display the selected color. The color selected is green when the security alert level is in a first condition, blue when the security alert level in the second condition, yellow when the security alert level is in a third condition, orange when the security alert level is in a fourth condition, and red when the security alert level is in a fifth condition.

### FIELD OF THE INVENTION

The present invention relates generally to a method and apparatus for displaying homeland security advisory information. More particularly, the present invention relates to a method and apparatus for displaying a color corresponding to a level of alert within the homeland security advisory system.

### BACKGROUND OF THE INVENTION

In response to recent terrorist attacks against the United States, particularly attacks carried out on Sep. 11, 2001, against the World Trade Center in New York City and the Pentagon located near Washington, D.C., the United States government has created the Office of Homeland Security. One of the functions of the Office of Homeland Security is to disseminate information regarding the perceived level of risk of terrorist attacks against the United States to Federal, State, and Local authorities and also to civilians.

One of the ways in which the Office of Homeland Security provides information regarding the risk of terrorist activity in the United States is through an advisory system, comprising five different levels of threat. Each level of threat has a corresponding color. For example, a low threat condition is associated with the color green, a guarded condition is associated with the color blue, an elevated condition is associated with the color yellow, a high condition is associated with the color orange and a severe condition is associated with the color red. Thus, the level of threat increases from green to red depending on the level of risk of imminent terrorist attacks as perceived by the United States government.

Currently, a level of threat or color associated with a level of threat is disseminated to the public via a plurality of media outlets. For example, television and radio news stations will announce the threat level. Also newspapers are used to announce the threat level. These systems which are currently used to communicate the threat level are limited in that they can only provide a level of threat at limited times. For example, newspapers are generally only printed once daily, and are thus only able to disseminate new information once a day. Television news casts are typically limited to displaying the risk threat level information at news broadcast times or are forced to interrupt regularly scheduled programming to display this type of information. In addition, a lag time may occur between a news agency receiving information of a new or change in threat level from a government agency and being able to display or disseminate that information to the public.

Radio and television broadcasts are also limited in conveying threat level information in that the radio or television must be on and tuned to a channel broadcasting threat level information. Many people are not around the television or radio for long periods during the day.

In some instances, it may be desirable to display a terrorist threat level to a specific group of people. For example, displaying a threat level in a police station or other government building would be useful to alert law enforcement officers and/or government employees of the threat level and any changes to a current level of threat. Thus, law enforcement and other personnel would be informed of a change or threat level without the need of being contacted individually.

Further, displaying a threat level in public places would also be useful for disseminating information regarding any changes in threat levels to civilians. For example, it may be useful to display threat levels in public areas such as in buildings or streets.

Thus, a need exists for a method and apparatus that can display a current level of condition and/or display a change in level of threat condition.

### SUMMARY OF THE INVENTION

It is therefore a feature and advantage of the present invention to provide an apparatus for displaying the color associated with a level of threat condition.

It is another feature and advantage of the present invention to provide a method for displaying a color associated with a level of threat condition.

The above and other features and advantages are achieved through the use of a novel method and apparatus for displaying a color associated with a level of threat condition as herein disclosed. In accordance with one embodiment of the present invention, a system for displaying homeland security advisory information is provided. The system comprises, a luminous display configured to illuminate a single color at a time and a controller configured to cause the display to selectively illuminate a red, orange, yellow, blue and green color. The controller is configured to receive and respond to a signal and to illuminate one of the colors.

In accordance with another embodiment of the present invention, a system for displaying a homeland security alert level is provided. The system comprises a beacon, comprising a means for displaying a single color at a time, means for receiving a signal, and means for controlling the displaying means to selectively cause the displaying means to illuminate a red, orange, yellow, blue and green color.

In accordance with another embodiment of the present invention, a method for communicating the homeland security alert level is provided. The method comprises the steps of providing a security alert beacon, receiving security alert level information and selecting a color for the security alert beacon to display. The color selected is a green color when the security alert level is in a first condition, a blue color when the security alert level is in second condition, a yellow color when the security alert level is in a third condition, an orange color when the security alert level is in a fourth condition, and a red color when the security alert level is in a fifth condition. The method also includes controlling the beacon to display the selected color.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a beacon in accordance with an embodiment of the present invention having five display portions each corresponding to a color representing a terrorist threat level.

FIG. 2 illustrates another beacon according to an embodiment of the present invention having a single display element capable of displaying different colors according to a terrorist threat level.

FIG. 3 illustrates a schematic diagram according to an embodiment of the present invention with a system of multiple beacons connected to a common controller for controlling which threat level is displayed on the beacons.

### DETAILED DESCRIPTION OF PREFERRED EMBODIMENTS OF THE INVENTION

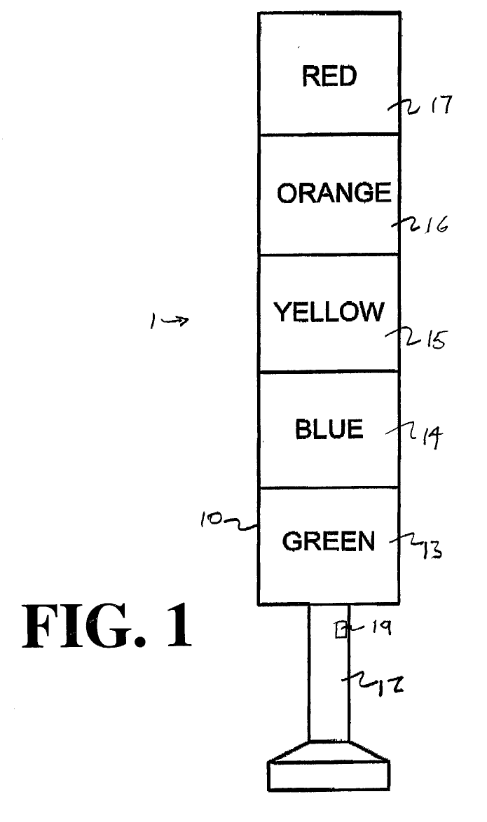

An embodiment of the present invention is illustrated in FIG. 1. Reference numeral 1 denotes generally a beacon for displaying a homeland security advisory threat level. The beacon 1 is encased in a housing 10. The housing 10 is mounted on a pedestal 12. While the housing 10 as shown in FIG. 1 is mounted on top of a pedestal 12 to comprise a free standing beacon 1, other embodiments of the invention may include the housing 10 mounted to a wall (not shown) or some other structure in lieu of being mounted to a pedestal 12 as shown in FIG. 1.

In some embodiments of the invention, within the housing 10 there are five subsections labeled 13-17. Each subsection 13-17 contains an apparatus for displaying a light. For example, subsection 13 displays a green light, subsection 14 displays a blue light, subsection 15 displays a yellow light, subsection 16 displays an orange light and subsection 17 displays a red light. These subsections 13-17 may include a white light behind a colored lens corresponding to green, blue, yellow, orange or red. Alternatively, these subsections 13-17 may simply contain a colored light corresponding to the green, blue, yellow, orange or red colors. The subsections 13-17 beacon 1 may be arranged vertically as shown in FIG. 1 or horizontally or in any other orientation.

Some preferred embodiments of the invention may control the beacon 1 with a switch 19 provided on the beacon 1 for selectively activating one of the colors to be illuminated. The switch 19 may be simple selector switch as shown in FIG. 1 located at a single location on the beacon 1 or it may be a plurality of switches associated with each one of the different subsections 13-17. The selector switch 19 allows an operator to selectively activate one of the colors at a time. The switch 19 may cause a signal to control which color on the beacon 1 is displayed.

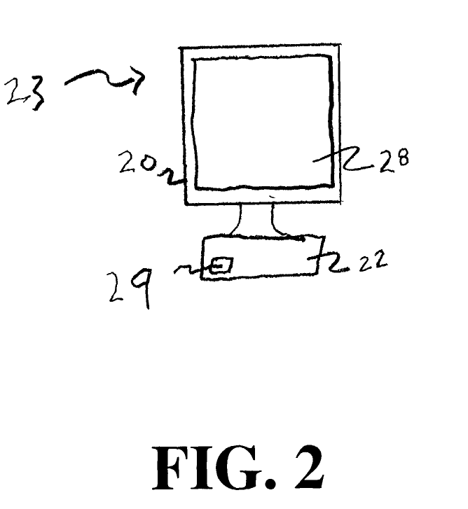

FIG. 2 illustrates another embodiment of the invention. The beacon shown in FIG. 2 is generally denoted by reference numeral 23. The beacon 23 may include a housing 20 mounted on a pedestal 22 or, as previously mentioned, the housing 20 may be configured to be mounted on some other structure than a pedestal 22. The beacon 23 shown in FIG. 2 shows a configuration where the housing 20 contains only one subsection 28 rather than the five subsections shown in FIG. 1. The single subsection 28 may be configured to display one of the five colors associated with the homeland security threat risk system, namely green, blue, yellow, orange or red. It may include the plurality of colored lights or it may comprise a single light with a plurality of five lenses or other means known in the art for making the light to appear to have a selected color. The colors may be selectively operated, for example, by a selector switch 29.

The embodiments shown in both FIGS. 1 and 2 illustrate a generally square shaped area for displaying the individual colors. The invention is not limited to a square shape but the beacon 1 and 23 may include subsections having round, rectangle, oval and/or other shapes. The illuminated color may appear to be steady and continuous or it may be varying, such as, for example, by flashing. The beacon 1 and 23 may be configured to flash in color and/or have a supplemental white strobe effect when a threat level has recently changed. The beacon 1 and 23 may be visible from several different directions. For example, the housing 10 and 20 may be cubed shaped or any other three dimensional shape and emit light from multiple angles or even 360° rather than just through a front face portion. Other beacon 1 and 23 configurations permitting the lights to be seen from multiple directions can be used.

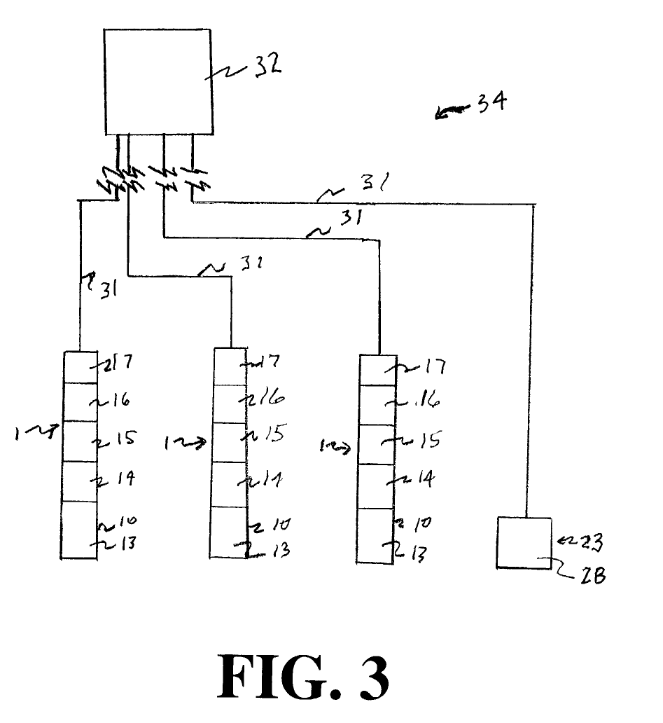

As shown in FIG. 3, the beacon 1 and 23 may be part of an overall system 34 for displaying homeland security terrorist threat warnings. As shown in schematic FIG. 3, several beacons 1 and 23 may be connected to a central controller 32 rather than a single switch 19 and 29 type controller. The system 34 may include beacons 1 and 23 of a single type or a mixture of different types of beacons 1 and 23 is as shown in FIG. 3. Some systems 34 may include only a single beacon 1 and 23.

The central controller 32 may include computer, a microprocessor, a logic unit, switch bank or other input and processing device for controlling which colored light is displayed in the beacons 1 and 23. The controller 32 may be connected by wires 31 to the beacons 1 and 23 or the controller 32 may communicate to the beacons 1 and 23 via a wireless device.

The beacons 1 and 23 may be deployed in various public areas such as on or near public streets or in public buildings. In addition, the beacons 1 and 23 may be deployed in law enforcement agencies, police stations, fire houses, government agencies or other places where the information may be useful.

The central controller 32 may be configured to receive information directly from a system operator or government agencies via the internet, by telephone, facsimile or other commonly used means for receiving communication. Alternatively, the central controller 32 may include a simple input device similar to the switch 19 and 29 for selectively activating a color to be displayed on the beacons 1 and 23. The central controller 32 sends a signal to the beacons 1 and 23 either via a wire 31 or wireless transmission.

A single system 34 may control several beacons 1 and 23. A system 34 may control all beacons 1 and 23 in a small area such as a building or as large an area as a city or even a region of the county.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for displaying homeland security advisory system information comprising:
a luminous display configured to illuminate a single color at a time; and
a controller configured to cause the display to selectively illuminate a red, orange, yellow, blue, and green color,
wherein the controller is configured to receive and respond to a signal to illuminate one of the colors.

2. The system of claim 1, wherein the display is comprised of five sub-displays and each sub-display is configured to illuminate one of the colors.

3. The system of claim 1, wherein the controller includes a selector switch.

4. The system of claim 1, wherein the controller receives the signal remotely via at least one of a wire or wireless transmission.

5. The system of claim 4, wherein the display and the controller are located in the beacon.

6. The system of claim 1, the signal originates from an official government source.

7. The system of claim 1, wherein the signal is transmitted, at least in part, over the internet.

8. The system of claim 1, further comprising a plurality of said displays each connected to the controller.

9. An apparatus for displaying homeland security alert level information comprising:
means for displaying a single color at a time; and
means for controlling the displaying means to selectively illuminate a red, orange, yellow, blue, and green color,
wherein the controlling means is configured to receive and respond to a signal to illuminate one of the colors.

10. The system of claim 9, wherein the displaying means is comprised of five sub-displays and each sub-display is configured to illuminate one of the colors.

11. The system of claim 9, further comprising a means for selecting one of the colors to be displayed.

12. The system of claim 9, wherein the controlling means receives the signal remotely via at least one of a wire or wireless transmission.

13. The system of claim 9, wherein the displaying means and the controlling means are located in a beacon.

14. The system of claim 9, the signal originates from an official government source.

15. The system of claim 9, wherein the signal is transmitted, at least in part, over the internet.

16. A method for displaying homeland security alert level information comprising the steps of:
selecting a color for a security alert beacon to display, wherein the color selected is a green color when the security alert level is in a first condition, a blue color when the security alert level is in a second condition, a yellow color when the security alert level is in a third condition, an orange color when the security alert level is in a fourth condition, a red color when the security alert level is in a fifth condition; and
manipulating the beacon to display the selected color.

17. The method of claim 16, wherein manipulating the beacon includes operating a selector switch configured to cause the beacon to display the selected color.

18. The method of claim 16, further comprising the steps of providing a plurality of security alert beacons and manipulating the beacons from a common controller.

19. The method of claim 16, further wherein the step of manipulating the beacon is performed with at least one of a device connected to the beacon with a wire and a wireless device.

20. The method of claim 16, further comprising displaying the beacon in a public area.

21. The method of claim 16, wherein the step of manipulating the beacon includes receiving a signal to cause the beacon to display the selected color.

22. The method of claim 21, wherein the signal is received via the internet.
